(19) United States
(12) Patent Application Publication
(10) Pub. No.: US 2026/0063858 A1
(43) Pub. Date: Mar. 5, 2026

(54) OPTICAL CONNECTOR AND OPTICAL WAVEGUIDE COMPONENT

(71) Applicant: SHINKO ELECTRIC INDUSTRIES CO., LTD., Nagano (JP)

(72) Inventor: Kenji YANAGISAWA, Nagano (JP)

(21) Appl. No.: 19/306,074

(22) Filed: Aug. 21, 2025

(30) Foreign Application Priority Data
Aug. 28, 2024 (JP) 2024-146307

(51) Int. Cl. G02B 6/42

(52) U.S. Cl. CPC G02B 6/4231

(57) ABSTRACT

An optical connector includes a block, an optical fiber, and a resin material. A first opening and a second opening are formed in the block. The first opening and the second opening reach a first surface of the block. The optical fiber is in the first opening. The optical fiber has a first end face exposed on the first surface. The resin material is in the second opening. A recess is formed in the resin material. The recess has a wall face continuous with the first surface.

### CROSS-REFERENCE TO RELATED APPLICATION

This application is based upon and claims priority to Japanese Patent Application No. 2024-146307, filed on Aug. 28, 2024, the entire contents of which are incorporated herein by reference.

### FIELD

A certain aspect of the embodiments discussed herein is related to optical connectors and optical waveguide components.

### BACKGROUND

Various techniques for optically coupling an optical fiber to an optical waveguide provided on a substrate have been proposed. (See Japanese Laid-open Patent Publication No. 2005-326602 and Japanese National Publication of International Patent Application No. 2022-509356.)

### SUMMARY

According to an aspect, an optical connector includes a block, an optical fiber, and a resin material. A first opening and a second opening are formed in the block. The first opening and the second opening reach a first surface of the block. The optical fiber is in the first opening. The optical fiber has a first end face exposed on the first surface. The resin material is in the second opening. A recess is formed in the resin material. The recess has a wall face continuous with the first surface.

The object and advantages of the invention will be realized and attained by means of the elements and combinations particularly pointed out in the claims.

It is to be understood that both the foregoing general description and the following detailed description are exemplary and explanatory and not restrictive of the invention, as claimed.

### BRIEF DESCRIPTION OF DRAWINGS

FIG. 1 is a plan view of an optical waveguide component according to a first embodiment;

FIG. 2 is an exploded plan view of the optical waveguide component according to the first embodiment;

FIGS. 3A and 3B are sectional views of the optical waveguide component according to the first embodiment;

FIG. 4 is a side view of an optical connector included in the optical waveguide component according to the first embodiment;

FIGS. 5A through 5G are side views illustrating a method of manufacturing the optical connector included in the optical waveguide component according to the first embodiment;

FIGS. 6A through 6G are sectional views illustrating the method of manufacturing the optical connector included in the optical waveguide component according to the first embodiment;

FIGS. 7A through 7C are sectional views illustrating a method of forming projections;

FIG. 8 is a plan view of an optical waveguide substrate included in an optical waveguide component according to a second embodiment;

FIG. 9 is a side view of the optical waveguide substrate included in the optical waveguide component according to the second embodiment; and

FIGS. 10A through 10D are sectional views illustrating a method of manufacturing the optical waveguide substrate included in the optical waveguide component according to the second embodiment.

### DESCRIPTION OF EMBODIMENTS

As noted above, there are various techniques for coupling an optical fiber to an optical waveguide, but alignment between the optical waveguide and the optical fiber is complicated.

According to an embodiment, it is possible to facilitate alignment between an optical waveguide and an optical fiber. For example, an optical connector and an optical waveguide component that facilitate alignment between an optical waveguide and an optical fiber are provided.

One or more embodiments are described below with reference to the accompanying drawings. In the following, elements having substantially the same functional configuration are referred to using the same reference numerals, and duplicate description thereof may be omitted.

### [a] First Embodiment

A first embodiment is described. The first embodiment relates to an optical waveguide component. The optical waveguide component includes an optical waveguide substrate and an optical connector.

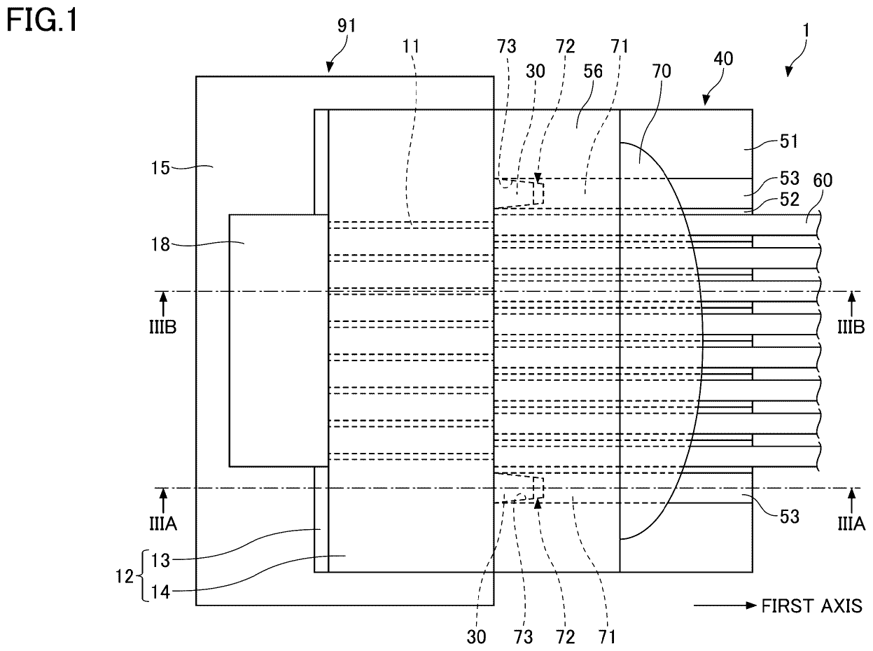

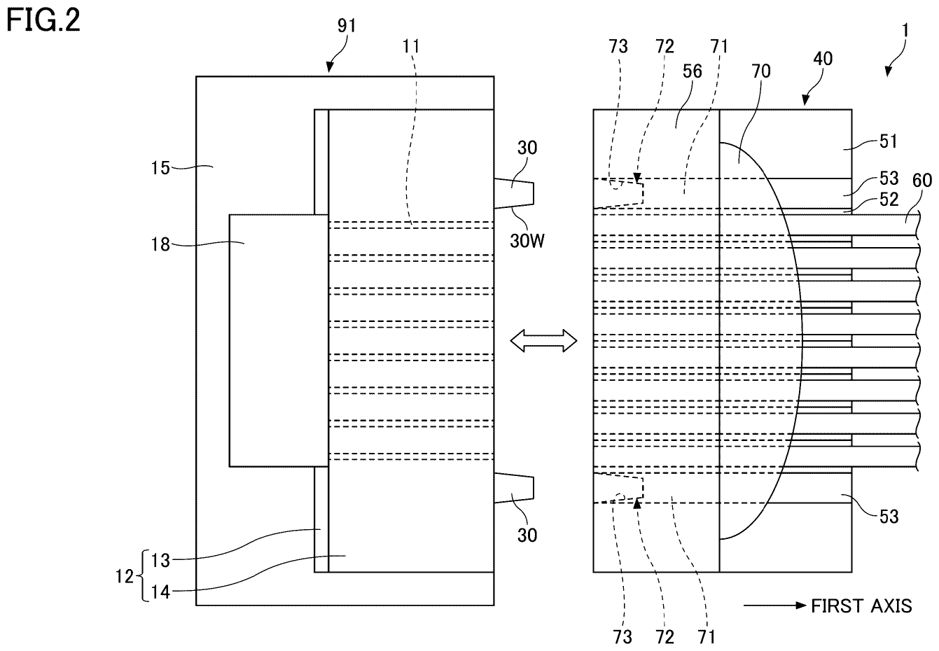

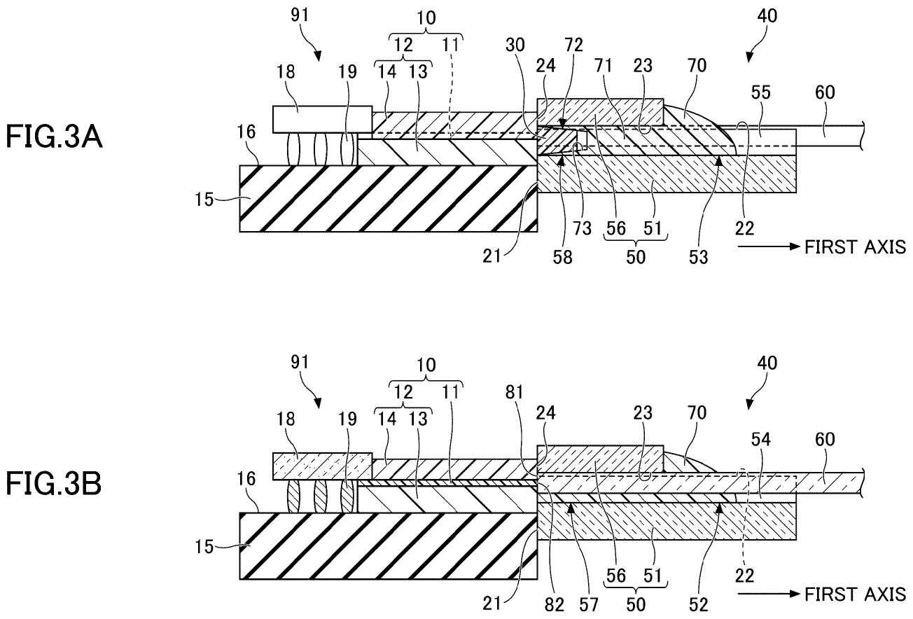

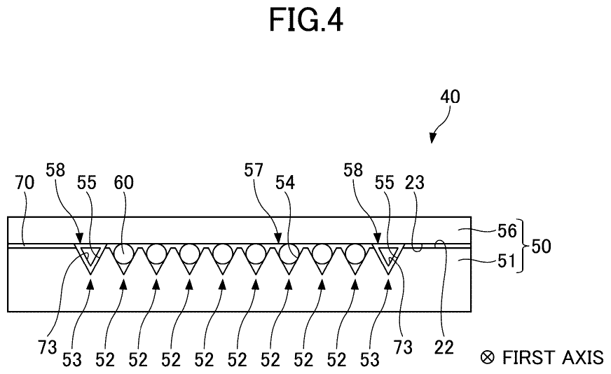

A structure of an optical waveguide component according to the first embodiment is described. FIG. 1 is a plan view of the optical waveguide component according to the first embodiment. FIG. 2 is an exploded plan view of the optical waveguide component according to the first embodiment. FIGS. 3A and 3B are sectional views of the optical waveguide component according to the first embodiment, taken along the line IIIA-IIIA and the line IIIB-IIIB, respectively, of FIG. 1. FIG. 4 is a side view of an optical connector included in the optical waveguide component according to the first embodiment.

Referring to FIGS. 1 through 4, an optical waveguide component 1 according to the first embodiment includes an optical waveguide substrate 91 and an optical connector 40.

The optical waveguide substrate 91 includes a substrate 15, an optical waveguide 10, an optical semiconductor chip 18, and two projections 30.

The substrate 15, which is, for example, a wiring substrate, includes wiring patterns (not depicted) and electrodes (not depicted). The optical waveguide 10 and the optical semiconductor chip 18 are provided on a principal surface 16 of the substrate 15.

According to this embodiment, for convenience of description, with respect to each part or element of the optical waveguide component 1, a surface facing in the same direction as the principal surface 16 of the substrate 15 may be referred to as “upper surface,” and a surface facing in the opposite direction may be referred to as “lower surface.” The optical waveguide component 1, however, may be used in an inverted position or oriented at any angle. Furthermore, a plan view refers to a view of an object taken in a direction normal to the principal surface 16 of the substrate 15, and a planar shape refers to the shape of an object viewed in a direction normal to the principal surface 16 of the substrate 15.

The optical waveguide 10 includes core layers 11 and cladding 12. The cladding 12 is provided around the core layers 11. The cladding 12 includes a first cladding layer 13 and a second cladding layer 14. The optical waveguide 10 is a polymer waveguide.

The first cladding layer 13 is provided on the substrate 15. The material of the first cladding layer 13 is, for example, organic resin such as epoxy resin or polyimide resin. The thickness of the first cladding layer 13 is, for example, approximately 10 μm to approximately 30 μm.

The core layers 11 each having a strip shape are provided on the first cladding layer 13. The material of the core layers 11 is, for example, organic resin such as epoxy resin or polyimide resin. The core layers 11 extend along a first axis. For example, a sectional shape of each core layer 11 perpendicular to a direction in which the core layers 11 extend is rectangular. The core layers 11 may each have a minute sectional area to obtain a single-mode optical waveguide. For example, the core layers 11 each have a width of 5 μm to 10 μm and a height of 5 μm to 10 μm. The core layers 11 each have a second end face 82 exposed on a below-described fourth surface 24 of the cladding 12. For example, the second end face 82 is flush with the fourth surface 24. The core layers 11 are an example of “core.”

The second cladding layer 14 is provided on the first cladding layer 13 and the core layers 11. The second cladding layer 14 covers the core layers 11. The material of the second cladding layer 14 is, for example, organic resin such as epoxy resin or polyimide resin. The thickness of the second cladding layer 14 is, for example, approximately 10 μm to approximately 30 μm.

According to the optical waveguide 10, the refractive index of the core layers 11 is higher than the refractive index of each of the first cladding layer 13 and the second cladding layer 14.

The optical semiconductor chip 18 includes optical devices (not depicted in the drawings) and electrodes 19, and is flip-chip mounted on the substrate 15. The optical semiconductor chip 18 is provided on the principal surface 16 of the substrate 15. The optical semiconductor chip 18 is positioned on one side of the optical waveguide 10 in the extension (longitudinal) direction of the core layers 11 with the optical devices being optically coupled to the optical waveguide 10. The optical devices may be either photodetectors or light emitters. The optical semiconductor chip 18 may include both of a photodetector and a light emitter.

The cladding 12 has the fourth surface 24 on the opposite side from the optical semiconductor chip 18 in the extension direction of the core layers 11. The fourth surface 24 crosses the first axis, and is preferably orthogonal to the first axis. For example, the fourth surface 24 is a planar surface.

The two projections 30 are provided on the fourth surface 24. The projections 30 protrude from the fourth surface 24 along the first axis. The projections 30 each have a truncated cone shape. The diameter of each projection 30 gradually decreases from the base toward the top end. For example, the projections 30 each have a wall face 30w that is inclined at approximately 7° from the first axis. The material of the projections 30 is, for example, organic resin such as epoxy resin or polyimide resin. The diameter of each projection 30 at the fourth surface 24 is, for example, 30 μm to 200 μm. The height of each projection 30 is, for example, 100 μm to 300 μm.

The optical connector 40 includes a block 50, optical fibers 60, and an adhesive layer 70.

The block 50 includes a substrate 51 and a lid 56. The block 50 has a first surface 21 that faces the fourth surface 24 of the cladding 12. For example, the first surface 21 is a planar surface.

The substrate 51 includes glass. The substrate 51 may be made of glass. The substrate 51 has a second surface 22. The second surface 22 crosses the first surface 21, and is preferably orthogonal to the first surface 21. Multiple first grooves 52 and two second grooves 53 are formed in the second surface 22. The number of the first grooves 52 is equal to the number of the core layers 11. The first grooves 52 and the second grooves 53 extend along the first axis. The first grooves 52 are aligned side by side in a direction parallel to the second surface 22 and perpendicular to the first axis. The second grooves 53 are provided one on the outer side of each of the two outermost first grooves 52 in the direction in which the first grooves 52 are aligned. That is, one of the second grooves 53 is provided adjacent to one of the two outermost first grooves 52 on its outer side, namely, on the side opposite from the first groove 52 adjacent to the one of the two outermost first grooves 52, and the other of the second grooves 53 is provided adjacent to the other of the two outermost first grooves 52 on its outer side, namely, on the side opposite from the first groove 52 adjacent to the other of the two outermost first grooves 52. In other words, the first grooves 52 are arranged adjacent to each other between the second grooves 53 in the direction in which the first grooves 52 are aligned. The first grooves 52 and the second grooves 53 each have a V-shaped cross section perpendicular to the first axis. The first grooves 52 are each defined by two wall faces 54, each of which is, for example, a planar surface. The second grooves 53 are each defined by two wall faces 55, each of which is, for example, a planar surface. Each of the angle formed by the two wall faces 54 and the angle formed by the two wall faces 55 is, for example, approximately 60°.

The optical fibers 60 are provided one in each of the first grooves 52. The optical fibers 60 are bare fibers. The optical fibers 60 each have a diameter of approximately 125 μm. Part of each optical fiber 60 is above the second surface 22. The optical fibers 60 each have a first end face 81 exposed on the first surface 21. For example, the first end face 81 is flush with the first surface 21. The first end face 81 faces the corresponding second end face 82.

The lid 56 includes glass. The lid 56 may be made of glass. The lid 56 has a third surface 23. The third surface 23 crosses the first surface 21, and is preferably orthogonal to the first surface 21. The third surface 23 faces the second surface 22. For example, the third surface 23 is a planar surface.

First openings 57 are defined by the wall faces 54 of the first grooves 52 and the third surface 23 of the lid 56. Second openings 58 are defined by the wall faces 55 of the second grooves 53 and the third surface 23 of the lid 56. The first openings 57 and the second openings 58 reach the first surface 21 and are continuous with the first surface 21. The first openings 57 and the second openings 58 extend along the first axis. The first openings 57 and the second openings 58 each have a substantially triangular section perpendicular to the first axis. The wall faces 54 and the wall faces 55 each have a length of, for example, 200 μm to 300 μm at this section. Of adjacent two of the first openings 57, one may be partly connected to part of the other. One or each of the two second openings 58 may be partly connected to part of one of the first openings 57 which one is adjacent to the one or each of the two second openings 58. The optical fibers 60 are each provided in a corresponding one of the first openings 57. The optical fibers 60 are in contact with the wall faces 54 of the first grooves 52 and the third surface 23 of the lid 56.

The adhesive layer 70 is between the substrate 51 and the lid 56. The substrate 51 and the lid 56 are bonded to each other by the adhesive layer 70. The adhesive layer 70 contains organic resin. For example, the adhesive layer 70 is made of UV-curable resin. The adhesive layer 70 is also present in the first openings 57 and the second openings 58. The adhesive layer 70 includes resin material 71 provided in the second openings 58.

A recess 72 is formed in the resin material 71 in each second opening 58. Each recess 72 has a wall face 73 continuous with the first surface 21. Each recess 72 extends along the first axis. Each recess 72 is tapered toward the bottom. For example, the width or diameter of each recess 72 gradually decreases toward the bottom. That is, the area of each recess 72 at its section perpendicular to the first axis decreases as the distance from the first surface 21 increases. For example, the wall face 73 of each recess 72 is inclined at approximately 7° from the first axis. The depth of each recess 72 is greater than or equal to the height of each projection 30 and is, for example, 200 μm to 300 μm.

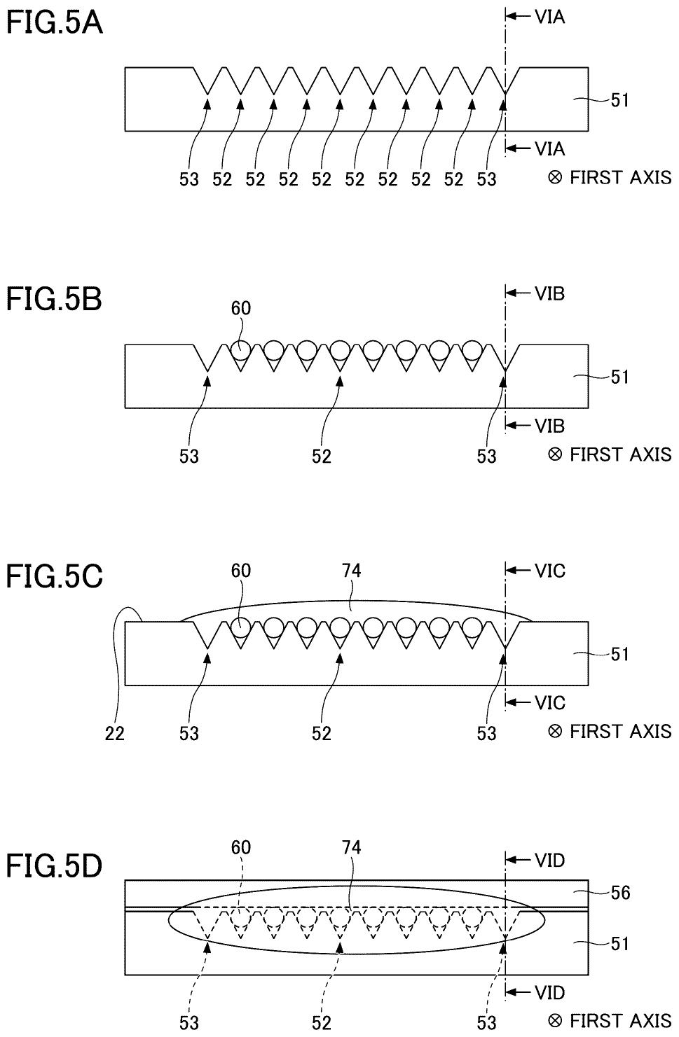

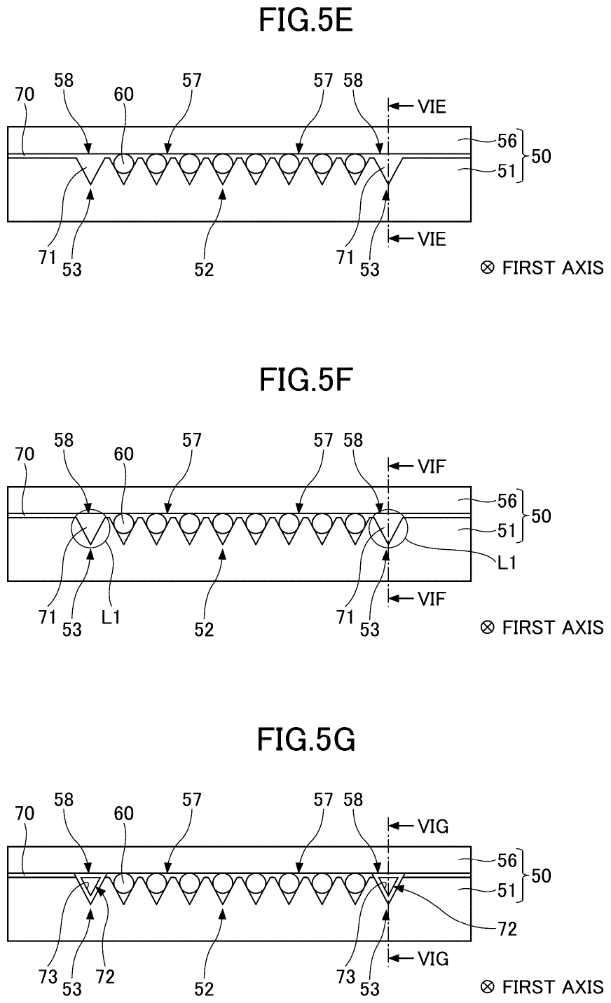

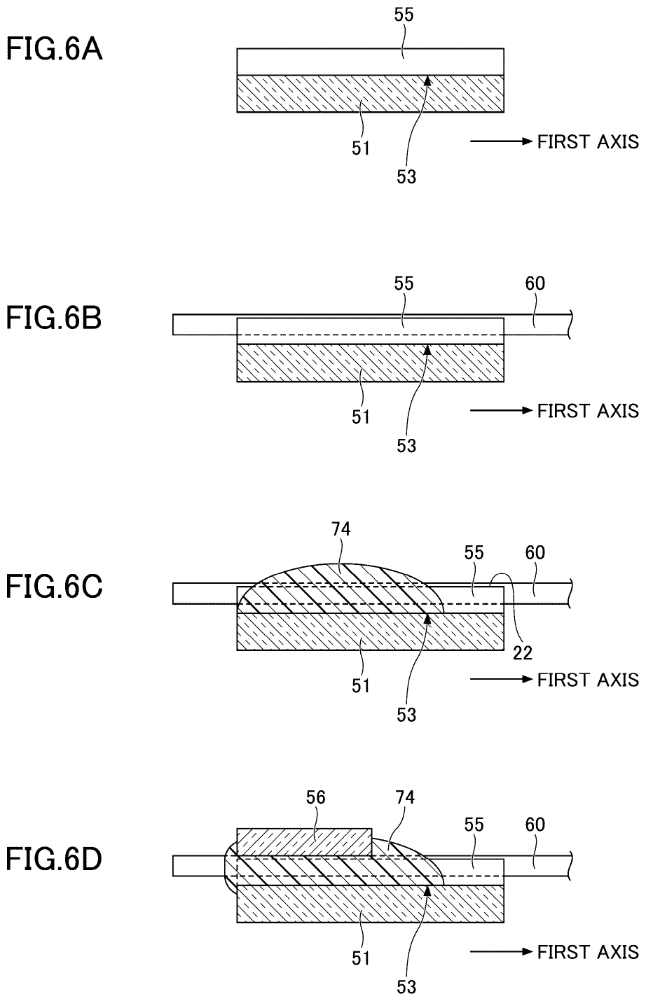

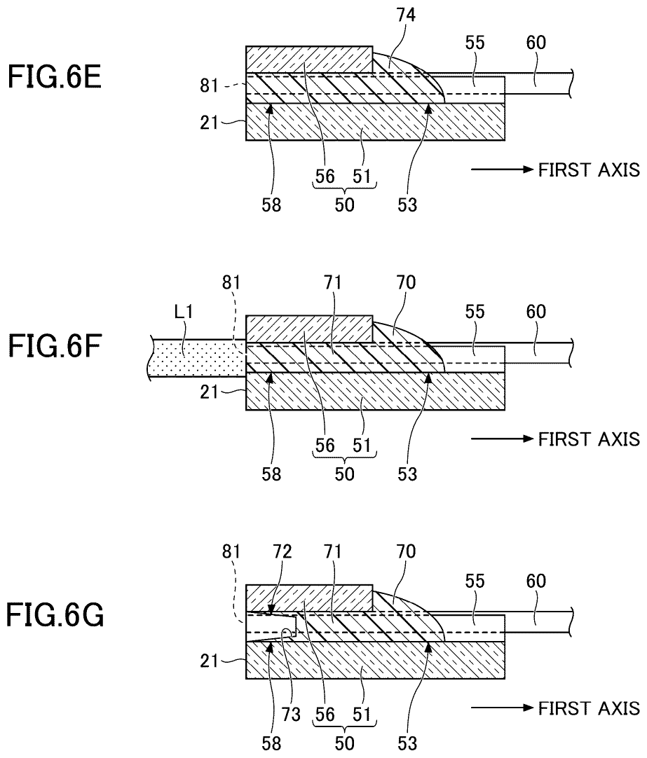

Next, a method of manufacturing the optical connector 40 is described. FIGS. 5A through 5G and FIGS. 6A through 6G are side views and sectional views, respectively, illustrating a method of manufacturing the optical connector 40. FIGS. 6A through 6G correspond to sections taken along the lines VIA-VIA, VIB-VIB, VIC-VIC, VID-VID, VIE-VIE, VIF-VIF and VIG-VIG in FIGS. 5A through 5G, respectively.

As illustrated in FIGS. 5A and 6A, the substrate 51 in which the first grooves 52 and the second grooves 53 are formed is prepared.

Next, as illustrated in FIGS. 5B and 6B, the optical fibers 60 are placed in the first grooves 52. At this point, the optical fibers 60 are arranged along the first axis to have their respective tips projecting from the first grooves 52.

Thereafter, as illustrated in FIGS. 5C and 6C, an adhesive 74 is applied on the second surface 22. For example, the material of the adhesive 74 is UV-curable resin. The adhesive 74 is also provided in the first grooves 52 and the second grooves 53.

Next, as illustrated in FIGS. 5D and 6D, the lid 56 is placed. At this point, a load is applied to the lid 56 from above to spread the adhesive 74. Then, the adhesive 74 is temporarily cured.

Next, as illustrated in FIGS. 5E and 6E, the substrate 51 and the lid 56 are polished to form the block 50 having the first surface 21 from the substrate 51 and the lid 56. At this point, the optical fibers 60 and the adhesive 74 as well are polished to form the first end face 81 on each optical fiber 60. The block 50 has the first openings 57 and the second openings 58. The adhesive 74 is cured to form the adhesive layer 70.

Thereafter, as illustrated in FIGS. 5F and 6F, the resin material 71, which is a portion of the adhesive layer 70 in the second openings 58, is exposed to laser light L1. For example, excimer laser light is used as the laser light L1.

As illustrated in FIGS. 5G and 6G, the recesses 72 having their respective wall faces 73 are formed in the resin material 71 by exposure to the laser light L1. In the case of irradiating the first surface 21 perpendicularly with excimer laser light serving as the laser light L1, the angle between the first axis and the wall face 73 is approximately 7°.

In this manner, the optical connector 40 can be manufactured.

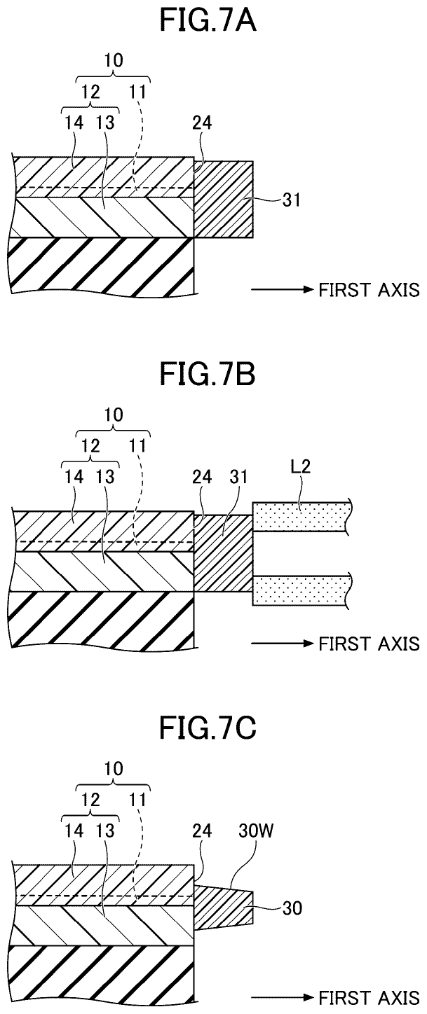

Next, a method of forming the projections 30 is described. FIGS. 7A through 7C are sectional views illustrating a method of forming the projections 30.

As illustrated in FIG. 7A, cylindrical protrusions 31 are formed in an area where the projections 30 are to be formed on the fourth surface 24 of the optical waveguide 10.

Thereafter, as illustrated in FIG. 7B, peripheral portions of the protrusions 31 are irradiated with laser light L2. For example, excimer laser light is used as the laser light L2.

As illustrated in FIG. 7C, the portions of the protrusions 31 irradiated with the laser light L2 are removed, so that the projections 30 each having a truncated cone shape are formed on the fourth surface 24. In the case of irradiating the fourth surface 24 perpendicularly with excimer laser light serving as the laser light L2, the angle between the first axis and the wall face 30w of each projection 30 is approximately 7°.

In this manner, the projections 30 can be formed.

The optical waveguide component 1 is used with the optical waveguide substrate 91 and the optical connector 40 being coupled to each other. In the case of coupling, the optical connector 40 is pressed against the optical waveguide 10 while fitting the projections 30 into the recesses 72. At this point, by providing an adhesive between the optical waveguide substrate 91 and the optical connector 40, it is possible to fix the optical connector 40 to the optical waveguide 10. The optical connector 40 may also be removably fixed to the optical waveguide 10 using a latch mechanism or the like, for example.

According to the first embodiment, the recesses 72 are formed in the optical connector 40, the projections 30 are provided on the fourth surface 24 of the optical waveguide substrate 91, and the projections 30 fit into the recesses 72. The recesses 72 can be formed with high positional accuracy by irradiation of the laser light L1, for example. The projections 30 can be formed with high positional accuracy by irradiation of the laser light L2, for example.

Thus, according to the first embodiment, the optical waveguide 10 and the optical fibers 60 can easily be aligned. For example, the optical waveguide 10 and the optical fibers 60 can be aligned with an accuracy of 4 μm or less. That is, it is possible to optically couple the optical waveguide 10 and the optical fibers 60 with high positional accuracy without performing optical axis adjustment.

### [b] Second Embodiment

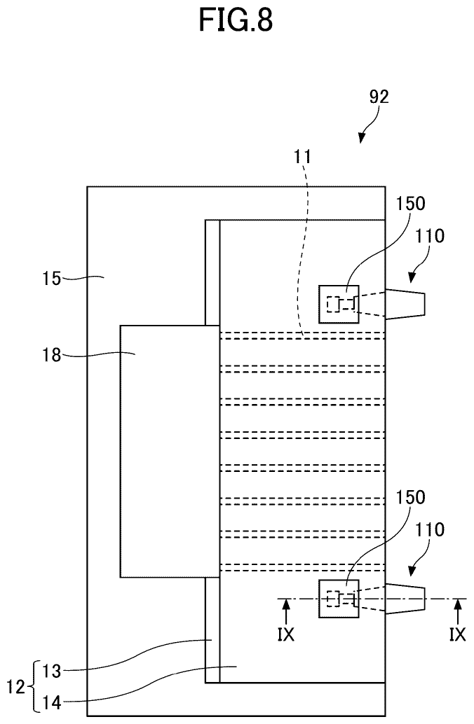

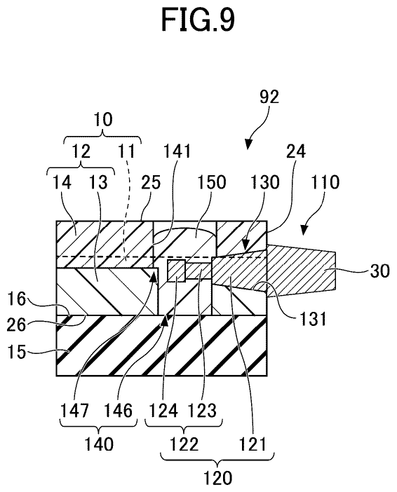

A second embodiment is described. The second embodiment is different from the first embodiment mainly in the configuration of an optical waveguide substrate. FIGS. 8 and 9 are a plan view and a sectional view, respectively, of an optical waveguide substrate included in an optical waveguide component according to the second embodiment. FIG. 9 is a sectional view taken along the line IX-IX of FIG. 8.

The optical waveguide component according to the second embodiment includes an optical waveguide substrate 92 in place of the optical waveguide substrate 91. The optical waveguide component according to the second embodiment includes the same optical connector 40 as in the first embodiment.

The same as the optical waveguide substrate 91 according to the first embodiment, the optical waveguide substrate 92 includes the substrate 15, the optical waveguide 10, and the optical semiconductor chip 18. The optical waveguide substrate 92 further includes two alignment members 110 and two bonding parts 150.

The cladding 12 has a fifth surface 25 that is continuous with the fourth surface 24 and has a sixth surface 26 on the opposite side from the fifth surface 25. The fifth surface 25 and the sixth surface 26 define the upper surface and the lower surface, respectively, of the cladding 12, for example. The sixth surface 26 faces and contacts the principal surface 16 of the substrate 15. According to the optical waveguide substrate 92, third openings 130 and fourth openings 140 are formed in the optical waveguide 10.

The third openings 130 have respective wall faces 131 that are continuous with the fourth surface 24. The third openings 130 extend along the first axis. The diameter of each third opening 130 gradually decreases toward its bottom. That is, the area of each third opening 130 at its section perpendicular to the first axis decreases as the distance from the fourth surface 24 increases. For example, the wall face 131 of each third opening 130 is inclined at approximately 7° from the first axis.

The fourth openings 140 have respective wall faces 141 that are continuous with the fifth surface 25. The fourth openings 140 extend perpendicularly to the first axis. The fourth openings 140 communicate with the third openings 130. The fourth openings 140 include respective holes 146 that pierce through the first cladding layer 13 and respective holes 147 that pierce through the second cladding layer 14. In a plan view, the holes 146 are within the corresponding holes 147.

The alignment members 110 include the respective projections 30 and respective supports 120. The alignment members 110 are, for example, formed of metal. The same as in the first embodiment, the projections 30 are provided on the fourth surface 24 and projects from the fourth surface 24. The third openings 130 are smaller in diameter than the projections 30 at the fourth surface 24. The supports 120 are connected to the corresponding projections 30 and extend into the corresponding fourth openings 140 through the corresponding third openings 130.

The supports 120 include respective first portions 121 that are in the corresponding third openings 130 and respective second portions 122 that are in the corresponding fourth openings 140. The second portions 122 include respective third portions 123 that are connected to the corresponding first portions 121 and respective fourth portions 124 that are separated from the first portions 121 and connected to the corresponding third portions 123 on the opposite side from the first portions 121. The third portions 123 are positioned between the first portions 121 and the fourth portions 124.

The first portions 121 extend along the first axis. The first portions 121 each have a truncated cone shape. The diameter of each first portion 121 gradually decreases as the distance from the corresponding projection 30 increases. For example, the wall face of each first portion 121 is inclined at approximately 7° from the first axis.

The third portions 123 and fourth portions 124 each have a cylindrical shape. The third portions 123 are smaller in diameter than the fourth portions 124. Furthermore, the diameter of each fourth portion 124 is smaller than the smallest diameter of each third opening 130.

For example, the projections 30, the first portions 121, the third portions 123 and the fourth portions 124 are coaxial.

The bonding parts 150 are provided, one in each fourth opening 140. The bonding parts 150 bond the supports 120 to the cladding 12. The material of the bonding parts 150 is, for example, organic resin such as epoxy resin or polyimide resin.

Otherwise, the optical waveguide substrate 92 may have the same configuration as the optical waveguide substrate 91.

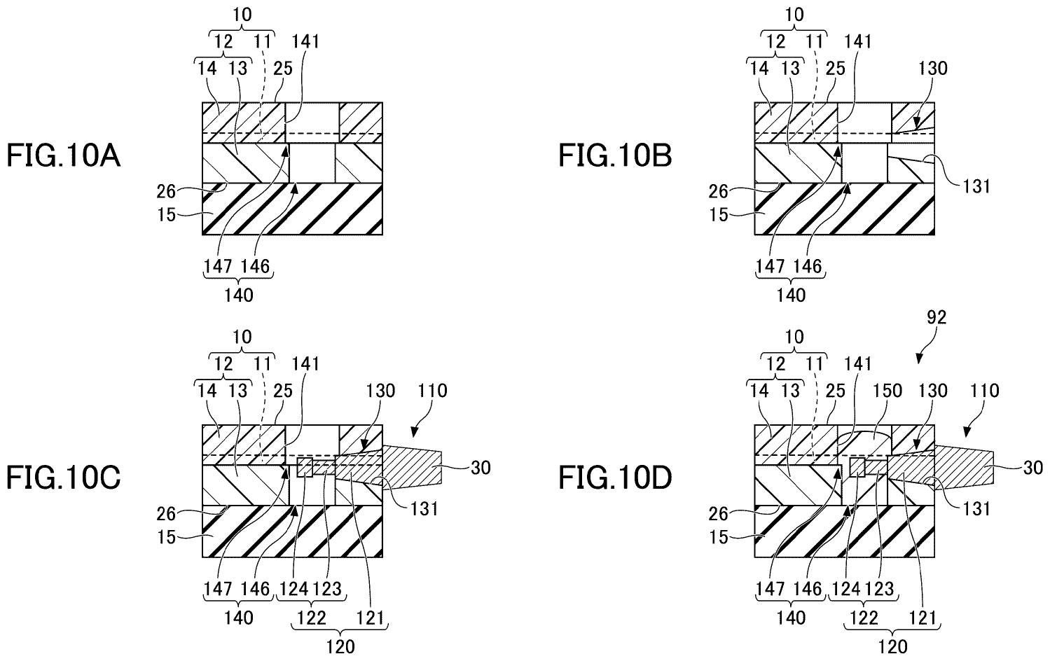

Next, a method of manufacturing the optical waveguide substrate 92 is described. FIGS. 10A through 10D are sectional views illustrating a method of manufacturing the optical waveguide substrate 92.

As illustrated in FIG. 10A, the optical waveguide 10 including the first cladding layer 13, the core layers 11, and the second cladding layer 14 is formed on the substrate 15. The holes 146 are formed by exposure to light and development when the first cladding layer 13 is formed, and the holes 147 are formed by exposure to light and development when the second cladding layer 14 is formed.

Next, as illustrated in FIG. 10B, the third openings 130 are formed in the cladding 12. For example, the third openings 130 may be formed by, for example, exposure to laser light the same as the recesses 72 are formed.

Thereafter, as illustrated in FIG. 10C, the alignment members 110 are inserted into the corresponding third openings 130. The alignment members 110 may be formed by, for example, processing metal wires or rods using a lathe. The alignment members 110 may also be formed by casting. By inserting the alignment members 110 into the third openings 130, the respective fourth portions 124 first, the fourth portions 124 and the third portions 123 pierce through the third openings 130 so that the wall faces of the first portions 121 fit against the inside (the wall faces 131) of the third openings 130.

Next, as illustrated in FIG. 10D, an adhesive is inserted into the fourth openings 140 and is cured to form the bonding parts 150. The bonding parts 150 bond the supports 120 of the alignment members 110 to the cladding 12.

Furthermore, although not graphically illustrated, the optical semiconductor chip 18 is flip-chip mounted on the substrate 15.

In this manner, the optical waveguide substrate 92 can be manufactured.

The same as the first embodiment, the second embodiment as well makes it possible to facilitate alignment between the optical waveguide 10 and the optical fibers 60. Furthermore, because the bonding parts 150 bond the supports 120 of the alignment members 110 to the cladding 12, it is possible to prevent detachment of the projections 30. Furthermore, because the diameter of each third opening 130 decreases as the distance from the fourth surface 24 increases, the position of each first portion 121 in a plane perpendicular to the first axis is likely to be stabilized. Moreover, because the third portions 123 are smaller in diameter than the fourth portions 124, the bonding parts 150 surround the third portions 123 between the cladding 12 and the fourth portions 124. Accordingly, even when a force is applied to the alignment members 110 in a direction away from the fourth surface 24, the bonding parts 150 between the cladding 12 and the fourth portions 124 resist the force, thus making it possible to prevent the alignment members 110 from being pulled out.

The material of the alignment members 110 is not limited to metal, and may be engineering plastic or the like. The alignment members 110 may be formed by injection molding or may be formed using a 3D printer.

All examples and conditional language provided herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority or inferiority of the invention. Although one or more embodiments of the present invention have been described in detail, it should be understood that the various changes, substitutions, and alterations could be made hereto without departing from the spirit and scope of the invention.

What is claimed is:

1. An optical connector comprising:
a block in which a first opening and a second opening are formed, the first opening and the second opening reaching a first surface of the block;
an optical fiber in the first opening, the optical fiber having a first end face exposed on the first surface; and
a resin material in the second opening,
wherein a recess is formed in the resin material, the recess having a wall face continuous with the first surface.

2. The optical connector as claimed in claim 1, wherein the recess is tapered toward a bottom of the recess.

3. The optical connector as claimed in claim 1, wherein the block includes
a substrate having a second surface in which a first groove and a second groove are formed, the first groove forming a part of the first opening, the second groove forming a part of the second opening; and
a lid having a third surface, the third surface facing the second surface.

4. The optical connector as claimed in claim 3, wherein each of the first groove and the second groove is defined by two wall faces.

5. The optical connector as claimed in claim 1, wherein the block includes glass.

6. An optical waveguide component comprising:
the optical connector as set forth in claim 1; and
an optical waveguide substrate,
the optical waveguide substrate including
a core having a second end face facing the first end face;
cladding surrounding the core, the cladding having a fourth surface facing the first surface; and
a projection projecting from the fourth surface and fitting into the recess.

7. The optical waveguide component as claimed in claim 6, wherein a diameter of the projection gradually decreases toward a top end of the projection.

8. The optical waveguide component as claimed in claim 6, wherein
the cladding has a fifth surface continuous with the fourth surface,
a third opening having a wall face continuous with the fourth surface and a fourth opening communicating with the third opening and having a wall face continuous with the fifth surface are formed in the cladding, and
the optical waveguide substrate further includes
an alignment member including
the projection; and
a support connected to the projection and extending into the fourth opening through the third opening; and
a bonding part provided in the fourth opening and bonding the support to the cladding.

9. The optical waveguide component as claimed in claim 8, wherein a diameter of the third opening gradually decreases as a distance from the fourth surface increases.

10. The optical waveguide component as claimed in claim 8, wherein
the support includes
a first portion in the third opening; and
a second portion in the fourth opening,
the second portion including
a third portion connected to the first portion; and
a fourth portion connected to the third portion on an opposite side from the first portion,
the third portion is positioned between the first portion and the fourth portion, and
the third portion is smaller in diameter than the fourth portion.

11. The optical waveguide component as claimed in claim 6, wherein the projection has a truncated cone shape.

12. An optical connector comprising:
a block in which a plurality of openings are formed, the plurality of openings extending from a first surface of the block;
a resin material provided in a first opening and a second opening among the plurality of openings; and
a plurality of optical fibers each provided in a corresponding one of a plurality of third openings among the plurality of openings, the plurality of third openings being arranged between the first opening and the second opening,
wherein a first recess and a second recess are formed in the resin material in the first opening and the second opening, respectively, the first recess and the second recess each having a wall face continuous with the first surface.

13. The optical connector as claimed in claim 12, wherein the first opening and the second opening are a first outermost opening and a second outermost opening, respectively, of the plurality of openings.

14. An optical waveguide component comprising:
the optical connector as set forth in claim 12; and
an optical waveguide substrate,
the optical waveguide substrate including
a plurality of cores aligned with the plurality of optical fibers;
cladding surrounding the plurality of cores, the cladding having a second surface facing the first surface; and
a first projection and a second projection projecting from the second surface and fitting into the first recess and the second recess, respectively.
